(19) United States
(12) Patent Application Publication
(10) Pub. No.: US 2015/0370564 A1
(43) Pub. Date: Dec. 24, 2015

(54) APPARATUS AND METHOD FOR ADDING A PROGRAMMABLE SHORT DELAY

(71) Applicants: Eli Kupermann, Maale Adumim (IL); Yuli Barcohen, Nokdim (IL); Suryaprasad Kareenahalli, Folsom, CA (US)

(72) Inventors: Eli Kupermann, Maale Adumim (IL); Yuli Barcohen, Nokdim (IL); Suryaprasad Kareenahalli, Folsom, CA (US)

(21) Appl. No.: 14/313,810

(22) Filed: Jun. 24, 2014

(51) Int. Cl. G06F 9/30; G06F 1/08

(52) U.S. Cl. CPC G06F 9/30141; G06F 1/08

(57) ABSTRACT

Described is an integrated circuit (IC) comprising: a processor; and a plurality of registers coupled to the processor, wherein the processor to select one of the registers of the plurality to stall execution of an instruction by a predetermined time.

### BACKGROUND

Short waits (e.g., less then 1 ms of wait time) may be used between execution of two instructions. For example, when a write instruction is executed by a processor, the next write instruction may need to wait some short period of time before the processor begins to execute the next write instruction. Such scheduling of certain instructions allows for proper computations by avoiding rewriting and reusing of the same register simultaneously. Wait periods between instructions are well known, however, implementing a short wait period is challenging.

For example, if short wait is implemented using a timer interrupt then significant overhead of interrupt handling is involved. This overhead of interrupt handling at times can be longer than the delay which the firmware desired to add between some instructions. Longer delay means slower performance because the processor is unnecessarily waiting even when it is ready to execute the next instruction.

An alternative approach to implementing short wait is to insert a busy loop between instructions. One example of a busy loop is:
for (i=0; i<DELAY_CYCLES; i++){ } or while (DMAisNotDone( );
   Busy loops are power greedy as they keep the processor busy with performing the loop function. Busy loops, as the one described above, also create hard to maintain firmware code because with every processor frequency change, the value of DELAY_CYCLES has to be re-calculated.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a system with apparatus for adding a short delay, according to one embodiment of the disclosure.

FIG. 2 illustrates another system with apparatus for adding a short delay, according to one embodiment of the disclosure.

FIG. 3 illustrates a table showing mapping of registers of the apparatus for adding a short delay, according to one embodiment of the disclosure.

FIG. 4 illustrates a flowchart of adding a short delay and reducing power consumption during processor stalling, according to one embodiment of the disclosure.

FIG. 5 is a smart device or a computer system or a SoC (System-on-Chip) having an apparatus for adding a short delay, according to one embodiment.

### DETAILED DESCRIPTION

Some embodiments describe a hardware based approach to providing short delays. In one embodiment, an apparatus for the hardware approach comprises a plurality of registers such that a processor selects for reading one or more of the registers to stall execution of an instruction by a predetermined amount of time. The predetermined amount of time is the short delay. In one embodiment, when the processor wants to introduce a short delay before executing a next instruction, the processor accesses one of the registers and reads from it a predefined time which is the time the processor remains stalled before executing the next instruction. In another embodiment, the processor determines the predetermined time of delay according to the address of the accessed or selected register. In one embodiment, while the processor is stalling, the clock to the processor is gated to save dynamic switching power consumption of the processor.

In one embodiment, for firmware to add this short delay, the firmware performs a simple read operation from a pre-defined hardware address associated with one of the registers of the plurality of registers. In such an embodiment, as soon as the read operation is completed, the firmware proceeds to service the next line in the code (or next instruction). In one embodiment, the duration of the read operation is defined by the value of delay in the accessed/selected register or by the address (e.g., 32 bit address) of the accessed/selected register.

There are many technical effects of the embodiments. For example, there may be no overhead introduced to the firmware flow by the embodiments because wait instructions for timer interrupts are not added. Another technical effect is that processor power consumption can be reduced by gating the clock to the processor when the processor or firmware is reading from one of the programmable registers. Processor power is also saved because no active polling is performed (e.g., no busy loops to be executed). Polling activities (e.g., busy loop) affect bus occupation and may actually slow down the DMA (Direct Memory Access) transfer. Here, hardware operation (e.g., in the case of waiting for DMA transfer completion) can be completed faster because processor polling activities for waiting is not performed. Other technical effects will be evident from the various embodiments described here.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical connection between the things that are connected, without any intermediary devices. The term “coupled” means either a direct electrical connection between the things that are connected or an indirect connection through one or more passive or active intermediary devices. The term “circuit” means one or more passive and/or active components that are arranged to cooperate with one another to provide a desired function. The term “signal” means at least one current signal, voltage signal or data/clock signal. The meaning of “a,” “an,” and “the” include plural references. The meaning of “in” includes “in” and “on.”

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level. The terms “substantially,” “close,” “approximately,” “near,” and “about,” generally refer to being within +/−20% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

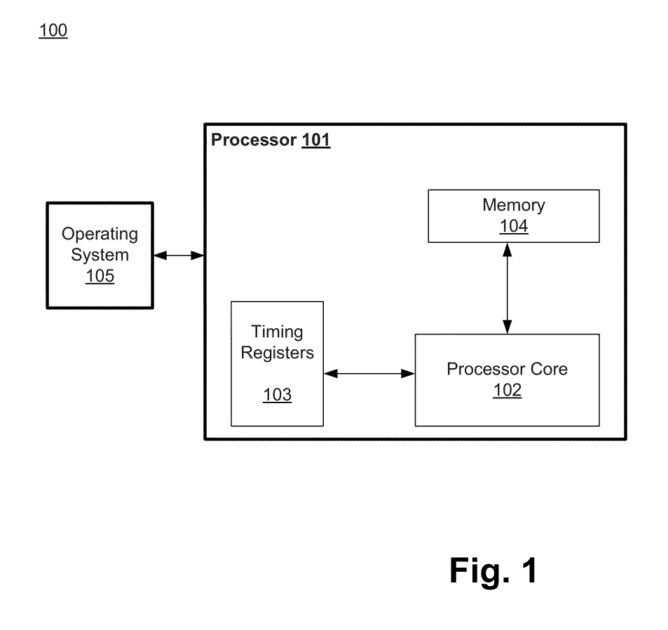

FIG. 1 illustrates a system 100 with apparatus for adding a short delay, according to one embodiment of the disclosure. In one embodiment, system 100 comprises Processor 101 having Processor Core 102, Timing Registers 103, and Memory 104; and Operating System 105. So as not to obscure the embodiments, other components and logic sections of Processor 101 are not shown. In one embodiment, Processor 101 is any processor. For example, Processor 101 is a general purpose processor, a multi-core processor, a Digital Signal Processor (DSP), an Application Specific Integrated Circuit (ASIC), an embedded processor, a System-on-Chip (SoC), etc. In one embodiment, Timing Registers 103 are a plurality of registers that define various delay units. For example, a first register may define one delay unit, a second register may define two delay units, and so on. In one embodiment, addresses of the registers (e.g., 32 bit address of the first register, second register, and so on) determine the amount of predetermined delay being added by the firmware or Processor 101.

In one embodiment, Processor Core 102 selects one of the registers depending on the amount of short delay that Processor Core 102 wants to add before executing a next instruction. This process of selecting one of the registers is also referred to here as reading the register. In one embodiment, Operating System 104 can be used to program the registers with different delay units. In one embodiment, a configuration register (i.e., one of the plurality of registers) can be used to define a delay unit. In such an embodiment, the absolute delay value in each register is determined according to the defined delay unit in the configuration register.

In one embodiment, the delay value added by Processor Core 102 is determined by the address of the selected register, and the unit of that delay is determined by the unit defined in the configuration register. In one such embodiment, the accessed or selected register is a read-only register while the configuration register is a writable register for defining the unit of delay.

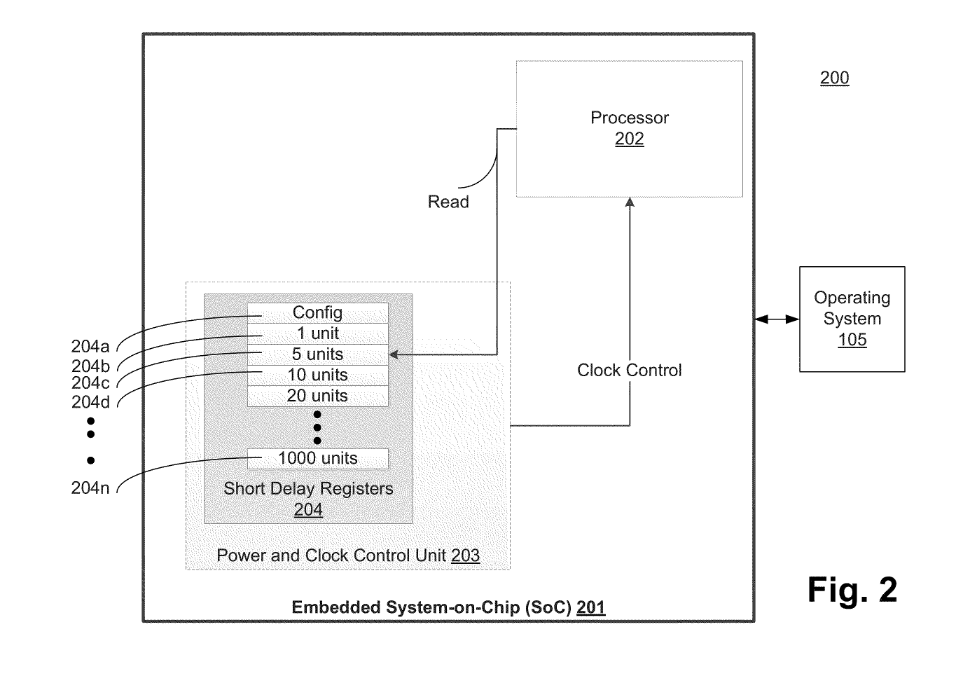

FIG. 2 illustrates another system 200 with apparatus for adding a short delay, according to one embodiment of the disclosure. It is pointed out that those elements of FIG. 2 having the same reference numbers (or names) as the elements of any other figure can operate or function in any manner similar to that described, but are not limited to such.

In one embodiment, system 200 comprises an Embedded SoC 201 which can communicatively couple to Operating System 105. In one embodiment, SoC 201 comprises Processor 202, and Power and Control Unit (PCU) 203. PCU 203 may be optional in one embodiment. In one embodiment, PCU 203 includes Short Delay Register 204. In one embodiment, Short Delay Register 204 is an Intellectual Property (IP) block. IP blocks are akin to Lego blocks for building a SoC or any processor. By having Short Delay Register 204 as an IP block, Short Delay Register 204 can be used in different processors with reduced design impact.

In one embodiment, Short Delay Register 204 comprises a plurality of registers 204a-204n, where 204a includes configuration (Config) information while others 204b-204n include different delay units. In one embodiment, Short Delay Register 204 is used to stall program flow execution for predefined time (e.g., time in the range of microseconds to hundreds of microseconds). While the embodiments show one configuration register 204a, and ‘b’ through ‘n’ registers with values, any number of registers may be used. In one embodiment, the interface of the IP block of Short Delay Register 204 includes a bus to access registers 204a-204n.

In one embodiment, PCU 203 (or any other control logic with similar functionality of power management) gates the clock signal used in Processor 202 when Processor 202 begins to read one of the registers of 204. In one embodiment, the duration of gating of the clock signal is the duration it takes to complete the read operation from one of the registers of 204. In one embodiment, Operating System 105 (or any other hardware firmware or software) can modify the value of Config register 204a. For example, the unit definition can be changed by overwriting the value of Config register 204a. In one embodiment, Operating System 105 (or any other hardware firmware or software) can also modify the values stored in other registers 204b-204n. In one embodiment, upon initialization of firmware, Config register 204a is initialized. In one embodiment, at power-up of Processor 101 (or SoC 201), Config register 204a is initialized. The process of initializing Config register 204a may involve downloading a delay unit.

In one embodiment, Config register 204a is used to specify the units for measuring the delays (for example, hundred nanoseconds, one microsecond, ten microseconds, etc.). In one embodiment, delay registers 204b-204n define different delay units when multiplied with the unit of Config register 204a to determine the delay for that register. In one embodiment, one or more of delay registers 204b-204n are accessed to stall the completion of the read operation (which begins by accessing that delay register) for the time specified in the delay register.

In one embodiment, addresses of delay registers 204b-204n define different delay units. For example, as address value increases, the delay value increases. In one embodiment, when one or more of delay registers 204b-204n are accessed for reading, the addresses of the one or more accessed delay registers 204b-204n is used to determine the delay to be added for stalling execution of an instruction.

In one embodiment, delay registers 204 comprise one programmable Config register 204a (i.e., writable register) which is a memory-mapped register (e.g., a 32 bit register) while other registers in Short Delay Register 204 are read-only registers. In other embodiments, depending on the instruction set architecture of Processor 101 (or SoC 201), the bit size for memory mapping may be different. For example, for a 64 bit instruction set architecture, Config register 204a (i.e., writable register) is a 64 bit memory-mapped register. In one embodiment, registers 204b-204n are read-only memory-mapped registers specifying different delays.

In one embodiment, to execute short stall for a desired duration, firmware executes the read operation from one of the registers 204b-204n in Short Delay Register 204. For 100 microseconds wait (e.g., Config register 204a delay unit is in microseconds), firmware may perform the following instruction:
uint32_t wait=*(volatile uint32_t*)SHORT_DELAY_{—}100UNITS_REG;
   and continue with execution of the next instruction after 100 microseconds is passed. In this example, 32 bit address value of accessed register is used to compute the wait time. In one embodiment, without having any setup (e.g., new instructions), when a program needs to wait for some short time, the program just reads a corresponding register. In one embodiment, the program can read several delay registers in a sequence to achieve a delay wait time which is not available by accessing any single register from registers 204b-204n.

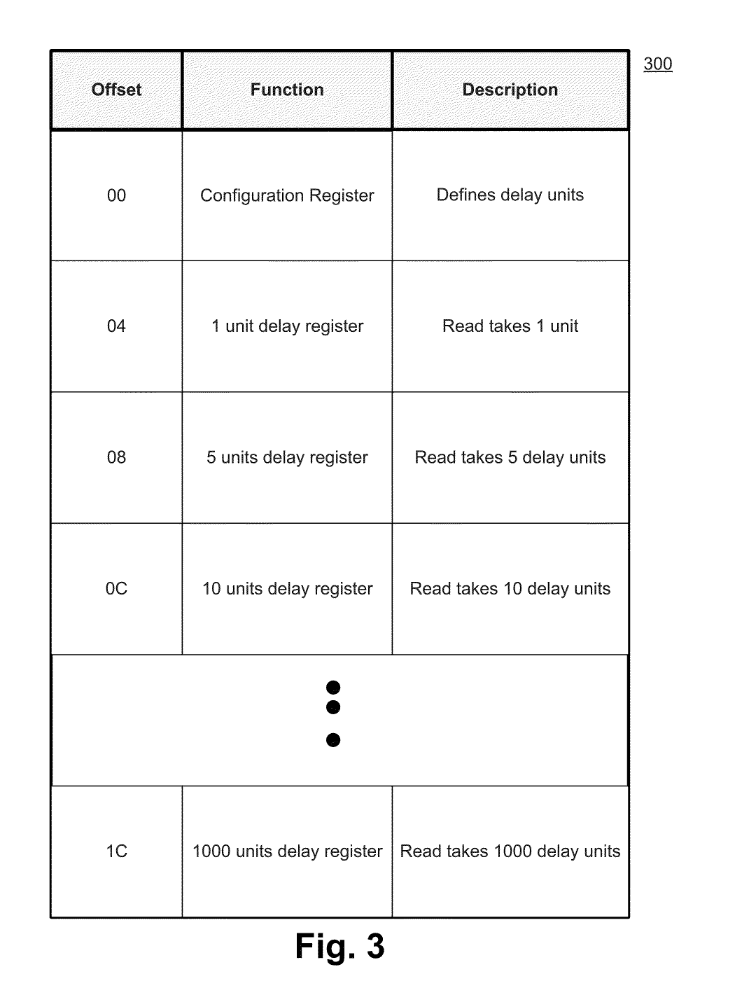

FIG. 3 illustrates a Table 300 showing mapping of registers of the apparatus for adding a short delay, according to one embodiment of the disclosure. It is pointed out that those elements of FIG. 3 having the same reference numbers (or names) as the elements of any other figure can operate or function in any manner similar to that described, but are not limited to such.

The first row of Table 300 lists Offset, Function, and Description. Here, Offset is the address difference between the registers in 204. With Offset 00, the Config register 204a can be accessed. Config register 204a defines delay units. The delay units provide the pre-scale for the clock of Processor 101 (or SoC 201). So, depending on the frequency of the clock, the delay values in each register amount to a different number of delay. In one embodiment, Config register 204a may define different delay units for different instructions. For example, for a first write operation, Config register 204a may be set to 100 ns of delay units. Likewise, for a second write operation, Config register 204a may be set to 1 μs, and so on.

With Offset 04, for example, a delay register 204b with one unit delay can be accessed. When register 204b is read, it means the processor (or firmware) takes one delay unit to complete the read operation from that register. For example, if Config register 204a is programmed to be 1 μs per delay unit, then reading from register 204b (i.e., the register that begins at Offset 04) will take 1×1=1 μs. In one embodiment, the result of the read operation from one of the registers 204b-n may be any pre-defined constant. In one embodiment, the addresses of Config register 204b plus the Offset 04 defines the address of delay register 204b. In one embodiment, the address of delay register 204b when accessed (i.e., when delay register 204b is read) results in determining the delay value associated with that address.

With Offset 08, for example, delay register 204c with five delay units is accessed. When register 204c is read, it means the processor (or firmware) takes five delay units to complete read operation from that register. For example, if Config register 204a is programmed to be 1 μs per delay unit, then reading from register 204c (i.e., the register that begins at Offset 08) will take 1×5=5 μs. In one embodiment, the addresses of Config register 204b plus the Offset 08 defines the address of delay register 204c. In one embodiment, the address of delay register 204c when accessed (i.e., when delay register 204c is read) results in determining the delay value associated with that address. The same explanation applies to registers that start at Offsets 0C, 10, 14, 18, 1C, etc.

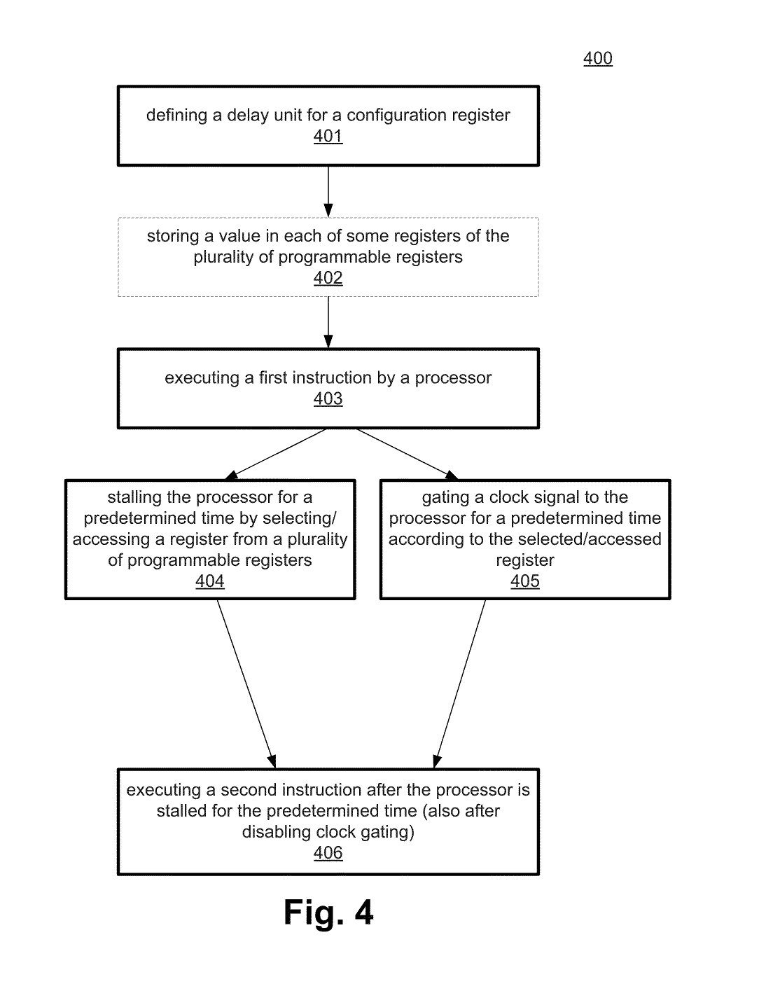

FIG. 4 illustrates a flowchart 400 of adding a short delay and reducing power consumption during processor stalling, according to one embodiment of the disclosure. Although the blocks in the flowcharts with reference to FIG. 4 are shown in a particular order, the order of the actions can be modified. Thus, the illustrated embodiments can be performed in a different order, and some actions/blocks may be performed in parallel. Some of the blocks and/or operations listed in FIG. 4 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 401, delay unit for Config register 204a is defined. For example, at initialization of firmware executing instructions, or at power-up of Processor 101 (or SoC 201) or any other defined event, delay unit for Config register 204a is defined. Config register 204a can also be defined again (i.e., the value in Config register 204a can be overwritten after initialization or power-up.).

At block 402, registers 204b-204n are programmed to store a read-only value. In one embodiment, registers 204b-204n are pre-programmed or hard-coded at the time of manufacture of Processor 101 (or SoC 201). In one embodiment, values in registers 204b-204n are programmed by fuses. In one embodiment, Operating System 104 programs registers 204b-204n. Any other method or scheme may be used to program registers 204a-204n according to any event or non-event.

In one embodiment, instead of programming registers 204b-204n with delay values, delay value for stalling an instruction is determined by the addresses of the registers 204b-204n. In such an embodiment, operation described in block 402 is not performed (i.e., registers 204b-204n are not programmed with delay values) which is why it block 402 is illustrated as dotted.

At block 403, Processor 101 (or SoC 201) or firmware executes a first instruction (e.g., a write instruction, memory fetch instruction, floating point instruction, etc.). In one embodiment, the architecture of Processor 101 (or SoC 201) may dictate that the next instruction to be executed should only execute after a predefined short delay to avoid errors in executing instructions. In such an embodiment, at block 404, depending on the executed first instruction, Processor 101 (or SoC 201) or firmware is stalled for a predetermined time by selecting or accessing (or reading) one of the registers 204b-204n from registers 204.

As described with reference to some embodiments, the value stored in the registers 204b-n may be used to calculate the predetermined time of wait. In some embodiment, accessing an address of one of the registers 204b-204n provides the predetermined time of wait (i.e., short delay).

At block 405, PCU 204 (or any other logic capable of controlling power management) gates a clock signal (using the Clock Control signal) for Processor 101 (or Processor 202) while block 404 is being executed. In this embodiment, blocks 405 and 404 are executed in parallel. In one embodiment, operation of block 405 is optional and not performed. For example, when the short delay is so short that any possible power savings from gating the clock is insignificant or zero then clock gating operation can be skipped.

By clock gating Processor 101 (or Processor 202), power is saved because Processor 101 (or Processor 202) may not be doing any useful work while being stalled anyways. At block 406, after the duration for read operation is complete, as defined by the predetermined time stored in the register (i.e., one of registers 204b-n) or by the value of the address of the accessed register, clock gating is disabled by PCU 204 and Processor 101 (or Processor 202) or firmware begins to execute a second instruction.

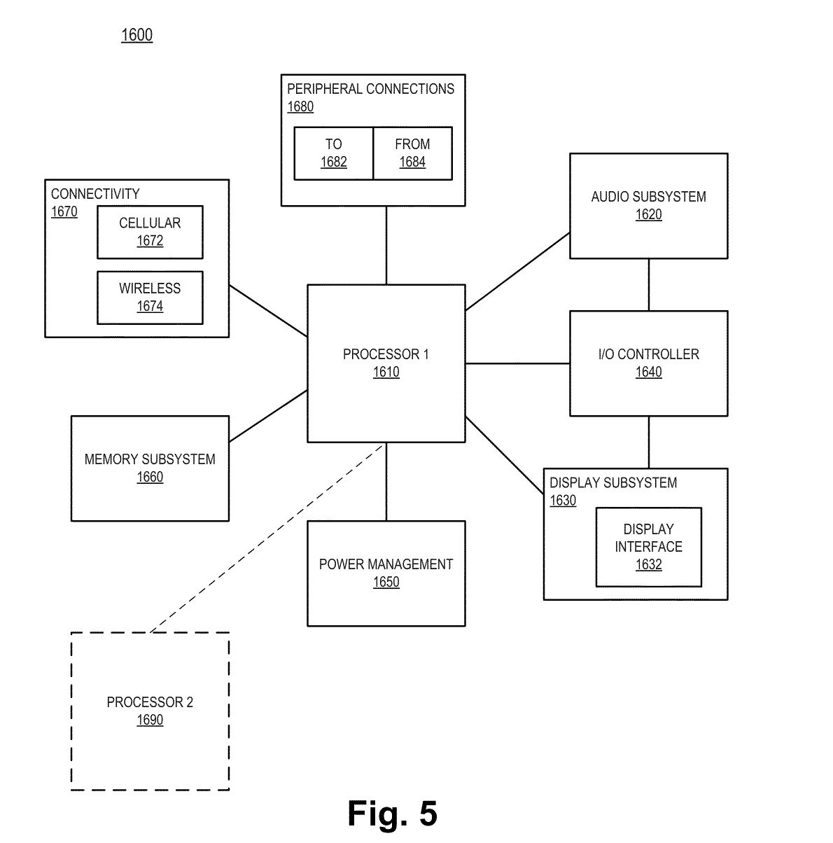

FIG. 5 is a smart device or a computer system or a SoC (System-on-Chip) having an apparatus for adding a short delay, according to one embodiment. It is pointed out that those elements of FIG. 5 having the same reference numbers (or names) as the elements of any other figure can operate or function in any manner similar to that described, but are not limited to such.

FIG. 5 illustrates a block diagram of an embodiment of a mobile device in which flat surface interface connectors could be used. In one embodiment, computing device 1600 represents a mobile computing device, such as a computing tablet, a mobile phone or smart-phone, a wireless-enabled e-reader, or other wireless mobile device. It will be understood that certain components are shown generally, and not all components of such a device are shown in computing device 1600.

In one embodiment, computing device 1600 includes a first processor 1610 with apparatus for adding a short delay and reducing power. Other blocks of the computing device 1600 may also include apparatus for adding a short delay and reducing power. The various embodiments of the present disclosure may also comprise a network interface within 1670 such as a wireless interface so that a system embodiment may be incorporated into a wireless device, for example, cell phone or personal digital assistant.

In one embodiment, processor 1610 (and processor 1690) can include one or more physical devices, such as microprocessors, application processors, microcontrollers, programmable logic devices, or other processing means. Processor 1690 may be optional. The processing operations performed by processor 1610 include the execution of an operating platform or operating system on which applications and/or device functions are executed. The processing operations include operations related to I/O (input/output) with a human user or with other devices, operations related to power management, and/or operations related to connecting the computing device 1600 to another device. The processing operations may also include operations related to audio I/O and/or display I/O.

In one embodiment, computing device 1600 includes audio subsystem 1620, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 1600, or connected to the computing device 1600. In one embodiment, a user interacts with the computing device 1600 by providing audio commands that are received and processed by processor 1610.

Display subsystem 1630 represents hardware (e.g., display devices) and software (e.g., drivers) components that provide a visual and/or tactile display for a user to interact with the computing device 1600. Display subsystem 1630 includes display interface 1632, which includes the particular screen or hardware device used to provide a display to a user. In one embodiment, display interface 1632 includes logic separate from processor 1610 to perform at least some processing related to the display. In one embodiment, display subsystem 1630 includes a touch screen (or touch pad) device that provides both output and input to a user.

I/O controller 1640 represents hardware devices and software components related to interaction with a user. I/O controller 1640 is operable to manage hardware that is part of audio subsystem 1620 and/or display subsystem 1630. Additionally, I/O controller 1640 illustrates a connection point for additional devices that connect to computing device 1600 through which a user might interact with the system. For example, devices that can be attached to the computing device 1600 might include microphone devices, speaker or stereo systems, video systems or other display devices, keyboard or keypad devices, or other I/O devices for use with specific applications such as card readers or other devices.

As mentioned above, I/O controller 1640 can interact with audio subsystem 1620 and/or display subsystem 1630. For example, input through a microphone or other audio device can provide input or commands for one or more applications or functions of the computing device 1600. Additionally, audio output can be provided instead of, or in addition to display output. In another example, if display subsystem 1630 includes a touch screen, the display device also acts as an input device, which can be at least partially managed by I/O controller 1640. There can also be additional buttons or switches on the computing device 1600 to provide I/O functions managed by I/O controller 1640.

In one embodiment, I/O controller 1640 manages devices such as accelerometers, cameras, light sensors or other environmental sensors, or other hardware that can be included in the computing device 1600. The input can be part of direct user interaction, as well as providing environmental input to the system to influence its operations (such as filtering for noise, adjusting displays for brightness detection, applying a flash for a camera, or other features).

In one embodiment, computing device 1600 includes power management 1650 that manages battery power usage, charging of the battery, and features related to power saving operation. Memory subsystem 1660 includes memory devices for storing information in computing device 1600. Memory can include nonvolatile (state does not change if power to the memory device is interrupted) and/or volatile (state is indeterminate if power to the memory device is interrupted) memory devices. Memory subsystem 1660 can store application data, user data, music, photos, documents, or other data, as well as system data (whether long-term or temporary) related to the execution of the applications and functions of the computing device 1600.

Elements of embodiments are also provided as a machine-readable medium (e.g., memory 1660) for storing the computer-executable instructions (e.g., instructions to implement any other processes discussed herein). The machine-readable medium (e.g., memory 1660) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 1670 includes hardware devices (e.g., wireless and/or wired connectors and communication hardware) and software components (e.g., drivers, protocol stacks) to enable the computing device 1600 to communicate with external devices. The computing device 1600 could be separate devices, such as other computing devices, wireless access points or base stations, as well as peripherals such as headsets, printers, or other devices.

Connectivity 1670 can include multiple different types of connectivity. To generalize, the computing device 1600 is illustrated with cellular connectivity 1672 and wireless connectivity 1674. Cellular connectivity 1672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 1674 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 1680 include hardware interfaces and connectors, as well as software components (e.g., drivers, protocol stacks) to make peripheral connections. It will be understood that the computing device 1600 could both be a peripheral device (“to” 1682) to other computing devices, as well as have peripheral devices (“from” 1684) connected to it. The computing device 1600 commonly has a “docking” connector to connect to other computing devices for purposes such as managing (e.g., downloading and/or uploading, changing, synchronizing) content on computing device 1600. Additionally, a docking connector can allow computing device 1600 to connect to certain peripherals that allow the computing device 1600 to control content output, for example, to audiovisual or other systems.

In addition to a proprietary docking connector or other proprietary connection hardware, the computing device 1600 can make peripheral connections 1680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, an IC is provided which comprises: a processor; and a plurality of registers coupled to the processor, wherein the processor to select one of the registers of the plurality to stall execution of an instruction by a predetermined time. In one embodiment, the plurality of registers includes a configuration register to define a delay unit. In one embodiment, each register of the plurality of registers has a different address, and wherein the address determines a number of delay units. In one embodiment, the configuration register is a writable register while the remaining registers of the plurality of registers are read-only registers.

In one embodiment, the plurality of registers includes registers each of which is operable to store a value indicating a different number of delay units. In one embodiment, the IC further comprises logic to determine the predetermined time by multiplying the stored value with the defined unit in the configuration register. In one embodiment, the IC further comprises a control logic, wherein the plurality of registers is stored in the control logic.

In one embodiment, the control logic is operable to gate a clock signal to the processor for a duration according to the stored value of a selected register. In one embodiment, the plurality of registers is programmable. In one embodiment, the IC further comprises logic operable to gate a clock signal to the processor according the predetermined time.

In another example, a system is provided which comprises: a memory; a processor, coupled to the memory, the processor including an IP block including: a plurality of registers each with a different address, wherein the processor to select one or more of the registers of the plurality to stall execution of an instruction according to a time determined by an address of the selected one or more registers of the plurality of registers; and a wireless interface for allowing the processor to communicate with another device.

In one embodiment, the system further comprises a display unit to display content processed by the processor. In one embodiment, the plurality of registers includes a configuration register to define a delay unit. In one embodiment, the configuration register is a writable register while the remaining registers of the plurality of registers are read-only registers. In one embodiment, the configuration register is programmed at power-up event of the processor. In one embodiment, the plurality of registers is programmable.

In another example, a method is provided which comprises: executing a first instruction by a processor; stalling the processor for a predetermined time by selecting a register from a plurality of registers; and executing a second instruction after the processor is stalled for the predetermined time. In one embodiment, the method further comprises defining a delay unit for a configuration register, wherein the configuration register is a register of the plurality of registers. In one embodiment, the method further comprises storing a value in each of some registers of the plurality of registers, wherein each stored value indicates a different number of delay units.

In one embodiment, the method further comprises determining the predetermined time using the address of the selected register. In one embodiment, the method further comprises gating a clock signal to the processor for a duration according to the stored value of the selected register. In one embodiment, the method further comprises gating a clock signal to the processor for a duration according to an address of the selected register.

In another example, an apparatus is provided which comprises: means for executing a first instruction by a processor; means for stalling the processor for a predetermined time by selecting a register from a plurality of registers; and means for executing a second instruction after the processor is stalled for the predetermined time.

In one embodiment, the apparatus further comprises means for defining a delay unit for a configuration register, wherein the configuration register is a register of the plurality of registers. In one embodiment, the apparatus further comprises means for storing a value in each of some registers of the plurality of registers, wherein each stored value indicates a different number of delay units. In one embodiment, the apparatus further comprises means for determining the predetermined time using the address of the selected register.

In one embodiment, the apparatus further comprises means for gating a clock signal to the processor for a duration according to the stored value of the selected register. In one embodiment, the apparatus further comprises means for gating a clock signal to the processor for a duration according to an address of the selected register.

In another example, an apparatus is provided which comprises: a plurality of registers each with a different address, wherein a logic to select one or more of the registers of the plurality to stall execution of an instruction according to a time determined by an address of the selected one or more registers of the plurality of registers. In one embodiment, the plurality of registers includes a configuration register to define a delay unit.

In one embodiment, the configuration register is a writable register while the remaining registers of the plurality of registers are read-only registers. In one embodiment, the configuration register is programmed at power-up event of the processor. In one embodiment, the plurality of registers is programmable.

In another example, a system is provided which comprises: a memory; a processor coupled to the memory; and a plurality of registers coupled to the processor, wherein the processor to select one of the registers of the plurality to stall execution of an instruction by a predetermined time; and a wireless interface for allowing the processor to communicate with another device.

In one embodiment, the plurality of registers includes a configuration register to define a delay unit. In one embodiment, each register of the plurality of registers has a different address, and wherein the address determines a number of delay units. In one embodiment, the configuration register is a writable register while the remaining registers of the plurality of registers are read-only registers.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An integrated circuit (IC) comprising:
a processor; and
a plurality of registers coupled to the processor, wherein the processor to select one of the registers of the plurality to stall execution of an instruction by a predetermined time.

2. The IC of claim 1, wherein the plurality of registers includes a configuration register to define a delay unit.

3. The IC of claim 2, wherein each register of the plurality of registers has a different address, and wherein the address determines a number of delay units.

4. The IC of claim 2, wherein the configuration register is a writable register while the remaining registers of the plurality of registers are read-only registers.

5. The IC of claim 2, wherein the plurality of registers includes registers each of which is operable to store a value indicating a different number of delay units.

6. The IC of claim 5 further comprises logic to determine the predetermined time by multiplying the stored value with the defined unit in the configuration register.

7. The IC of claim 1 further comprises a control logic, wherein the plurality of registers is stored in the control logic.

8. The IC of claim 7, wherein the control logic is operable to gate a clock signal to the processor for a duration according to the stored value of a selected register.

9. The IC of claim 1, wherein the plurality of registers is programmable.

10. The IC of claim 1 further comprises logic operable to gate a clock signal to the processor according the predetermined time.

11. A system comprising:
a memory;
a processor, coupled to the memory, the processor including an intellectual property (IP) block including:
a plurality of registers each with a different address, wherein the processor to select one or more of the registers of the plurality to stall execution of an instruction according to a time determined by an address of the selected one or more registers of the plurality of registers; and
a wireless interface for allowing the processor to communicate with another device.

12. The system of claim 11 further comprises a display unit to display content processed by the processor.

13. The system of claim 11, wherein the plurality of registers includes a configuration register to define a delay unit.

14. The system of claim 13, wherein the configuration register is a writable register while the remaining registers of the plurality of registers are read-only registers.

15. The system of claim 14, wherein the configuration register is programmed at power-up event of the processor.

16. The system of claim 11, wherein the plurality of registers is programmable.

17. A method comprising:
executing a first instruction by a processor;
stalling the processor for a predetermined time by selecting a register from a plurality of registers; and
executing a second instruction after the processor is stalled for the predetermined time.

18. The method of claim 17 further comprises defining a delay unit for a configuration register, wherein the configuration register is a register of the plurality of registers.

19. The method of claim 18 further comprises storing a value in each of some registers of the plurality of registers, wherein each stored value indicates a different number of delay units.

20. The method of claim 17 further comprises determining the predetermined time using the address of the selected register.

21. The method of claim 18 further comprises gating a clock signal to the processor for a duration according to the stored value of the selected register.

22. The method of claim 17 further comprises gating a clock signal to the processor for a duration according to an address of the selected register.
